(19) United States
(12) Patent Application Publication
(10) Pub. No.: US 2019/0266209 A1
(43) Pub. Date: Aug. 29, 2019

(54) METHODS AND SYSTEMS FOR ENHANCED NON-DESTRUCTIVE TESTING (NDT) PRODUCT LABELS AND USE THEREOF

(71) Applicant: Illinois Tools Works Inc., Glenview, IL (US)

(72) Inventors: David John Fry, Evanston, IL (US); Sakif Bin Ferdous, Skokie, IL (US)

(21) Appl. No.: 16/281,832

(22) Filed: Feb. 21, 2019

Related U.S. Application Data
(60) Provisional application No. 62/634,426, filed on Feb. 23, 2018.

(51) Int. Cl. G06F 16/955; G06K 19/06; G06K 7/14

(52) U.S. Cl. CPC G06F 16/9554; G06K 7/1413; G06K 7/1417; G06K 19/06009

(57) ABSTRACT

Systems and methods are provided for enhanced non-destructive testing (NDT) product labels and use thereof. An example label may be configured for application to non-destructive testing (NDT) products, with the label including a readable code that incorporates information relating to a particular NDT product sample. The information uniquely identifies the NDT product sample and/or a batch that includes the NDT product sample. An example system may include a reader configured for reading machine-readable code incorporated into a label applied to an NDT product, and circuitry configured for processing data obtained from the machine-readable code. The circuitry may extract based on the processing, information relating to the NDT product, the information including a unique product identifier and/or a unique batch identifier. The circuitry may then trigger based on the unique product identifier and/or the unique batch identifier, actions associated with the NDT product and/or use of the NDT product.

### CLAIM OF PRIORITY

This patent application makes reference to, claims priority to and claims benefit from U.S. Provisional Patent Application Ser. No. 62/634,426, filed on Feb. 23, 2018. The above identified application is hereby incorporated herein by reference in its entirety.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle, eddy-current, liquid penetrant, radiographic, ultrasonic, and visual testing. Non-destructive testing (NDT) is commonly used in such fields as mechanical engineering, petroleum engineering, electrical engineering, systems engineering, aeronautical engineering, medicine, art, and the like.

In some instances, dedicated material and/or products may be used in non-destructive testing. For example, non-destructive testing of particular type of articles may entail applying (e.g., by spraying on or pouring into) would-be tested article material that is configured for performing the non-destructive testing. In this regard, the material may be selected and/or made based on having particular magnetic, visual, etc. characteristics suitable for the non-destructive testing—e.g., allowing detecting defects and imperfections in the would-be tested article. Such material (referred as “NDT material” or “NDT product” hereinafter) may be offered or provided in suitable manner—e.g., being packaged in cans or similar containers, which may be obtained (when) needed and applied to the article being tested.

In some instances, it may be desirable to obtain information regarding NDT material or products. However, conventional approaches for obtaining such information, if any existed, may be cumbersome, inefficient, and/or costly.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to product testing. More specifically, various implementations in accordance with the present disclosure are directed to enhanced non-destructive testing (NDT) product labels and use thereof, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 shows an example end-to-end use scenario of non-destructive testing (NDT) products with enhanced readable codes, in accordance with aspects of the present disclosure.

FIG. 2 depicts an example system for generating and/or applying readable codes for non-destructive testing (NDT) products, in accordance with aspects of this disclosure.

FIG. 3 depicts a flowchart of an example process for generating readable codes for non-destructive testing (NDT) products, in accordance with aspects of the present disclosure.

FIG. 4 depicts a flowchart of an example process for utilizing readable codes for non-destructive testing (NDT) products, in accordance with aspects of the present disclosure.

### DETAILED DESCRIPTION

Various implementations in accordance with the present disclosure are directed to providing enhanced and optimized product information during non-destructive testing (NDT). In this regard, as noted above, NDT products may be used in conjunction with non-destructive testing. For example, non-destructive testing of particular type of articles may entail applying (e.g., by spraying on or pouring into) would-be tested article material that is configured for performing the non-destructive testing, such as based on having particular magnetic, visual, etc. characteristics suitable for the non-destructive testing. Such NDT products may be offered or provided in suitable manner—e.g., being packaged in cans or similar containers, which may be obtained (when) needed and applied to the article being tested. In some instances, it may be desirable to obtain information regarding NDT products, or batches containing the particular NDT products being used. The present disclosure provides enhanced solutions for enabling for obtaining information relating to NDT products, such as by use of labels or similar means for incorporating information (e.g., onto packaging of the NDT products), relating to the NDT products and/or batches that include the NDT products. The advantages of these enhanced solutions include for quicker, less costly, and more convenient ways for users to obtain necessary information that allow performing non-destruction testing correctly and efficiently.

An example system in accordance with the present disclosure may comprise a reading component configured for reading machine-readable code incorporated into a label applied to a non-destructive testing (NDT) product; and one or more circuits configured to process data obtained from the machine-readable code; extract based on the processing, information relating to the NDT product; wherein the extracted information may comprise at least one of a unique product identifier and a unique batch identifier; and trigger based on at least one of the unique product identifier and the unique batch identifier, one or more actions associated with at least one of the NDT product and use of the NDT product.

In an example implementation, the system may comprise an output component configured for providing output based on or relating to the triggered one or more actions. The output component may comprise a display.

In an example implementation, the one or more circuits may be configured to automatically establish a connection to a remote entity associated with the NDT product.

In an example implementation, the one or more circuits may be configured to obtain from the remote entity information relating to at least one of the NDT product and a specific batch that may comprise to the NDT product.

In an example implementation, the one or more circuits may be configured to obtain from the remote entity information relating to the specific batch based on the unique batch identifier.

In an example implementation, the one or more circuits may be configured to open a user interface for providing information relating to one or more of the NDT product, use of the NDT product, and a batch that comprises the NDT product.

In an example implementation, the one or more circuits may be configured to automatically open a specific webpage or website associated with the NDT product based on the extracted information.

A non-transitory machine-readable storage in accordance with the present disclosure may have stored thereon a computer program that may comprise at least one code section that may comprise a plurality of instructions executable by a machine that may comprise at least one processor and/or circuit, to cause the machine to perform a plurality of steps that may comprise reading machine-readable code incorporated into a label applied to a non-destructive testing (NDT) product; processing information obtained from the machine-readable code; extracting based on the processing, information relating to the NDT product; wherein the extracted information may comprise at least one of a unique product identifier and a unique batch identifier; and performing one or more actions associated with the NDT product based on at least one of the unique product identifier and the unique batch identifier.

In an example implementation, the one or more actions may comprise automatically establishing a connection to a remote entity associated with the NDT product.

In an example implementation, the one or more actions may comprise obtaining from the remote entity information relating to at least one of the NDT product and a specific batch that may comprise to the NDT product.

In an example implementation, the one or more actions may comprise obtaining from the remote entity information relating to the specific batch based on the unique batch identifier.

In an example implementation, the one or more actions may comprise opening a user interface for providing information relating to one or more of the NDT product, use of the NDT product, and a batch that comprises the NDT product.

In an example implementation, the one or more actions may comprise automatically opening a specific webpage or website associated with the NDT product based on the extracted information.

A label in accordance with the present disclosure may be configured for application to non-destructive testing (NDT) products and may comprise a readable code that incorporates information relating to a particular non-destructive testing (NDT) product sample, the information being configured to uniquely identify at least one of the NDT product sample and a batch that comprises the NDT product sample. In this regard, the readable code may be configured for being read via a machine, and the reading of the readable code allows for extraction of the incorporated information.

In an example implementation, the readable code may comprise a barcode.

In an example implementation, the readable code may comprise a QR code.

In an example implementation, the readable code may be configured for reading via scanning.

In an example implementation, the readable code may be configured for causing the machine to automatically open a specific webpage or website associated with the particular NDT product based on the extracted information.

In an example implementation, the readable code may be configured for causing the machine to open a user interface for providing information relating to one or more of the NDT product, use of the NDT product, and a batch that comprises the NDT product.

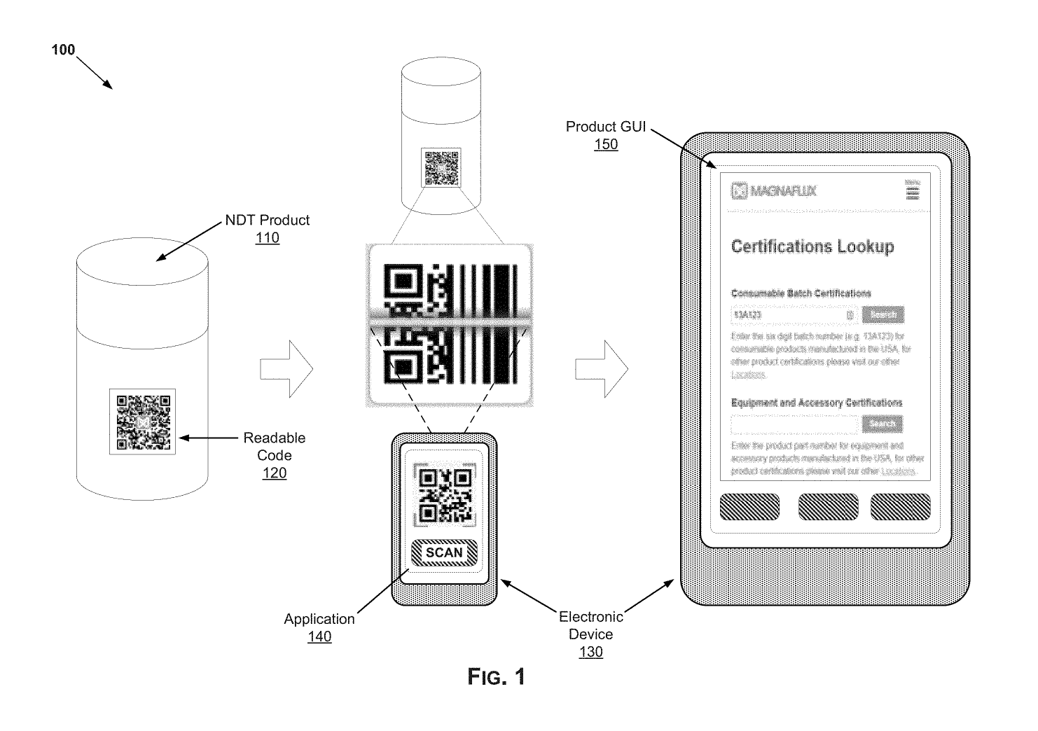

FIG. 1 shows an example end-to-end use scenario of non-destructive testing (NDT) products with enhanced readable codes, in accordance with aspects of the present disclosure. Shown in FIG. 1 is a use scenario or chain 100, in which a readable code (particularly supporting enhanced operations and/or use of the product) is applied to an NDT product 110.

The NDT product 110 may be packaged as or into a suitable container, such as based on the form or characteristics of material being used in the non-destructive testing. For example, the NDT product 110 may be packaged as a spray can containing a spray-able material that may be used during non-destructive testing—e.g., being sprayed on or within a would-be tested article, to enable finding defects or imperfections therein (if any existed), such as by reacting to particular stimulus (e.g., light, heat, etc.), but may then be removed (e.g., by washing it off, or otherwise removing it) from the tested article without damaging or altering the test article. Nonetheless, the disclosure is not limited to spray cans and spray-able material, and may be used similarly with other types of material and/or containers suitable therefor—e.g., consumables packaged totes, barrels, pails, etc.

In some instances, it may be desirable to provide information relating to the NDT product (and/or material therein) in general, and additionally information relating to the particular NDT product item and/or batch that includes that the NDT product item. For example, this may be done using a label (or nameplate) 120 which may be adhered or attached to the NDT product 110. In this regard, the label 120 may be configured, in accordance with the present disclosure, to provide information not typically available, and/or to allow obtaining such information conveniently and adaptively in manner not currently possible.

In an example implementation, the label 120 includes a readable code, which is configured to be read by suitable machines or systems, particularly ones comprising (and/or coupled to) suitable reading components or devices that can read out the readable code. In this regard, such machine or system comprises suitable circuitry for implementing various aspects of the present disclosure. Such circuitry may comprise, for example, general or dedicated processing circuitry, storage circuitry, input/output circuitry (and related/corresponding input/output devices), communication-related circuitry, etc. In some instance, such machine or system may be implemented as a single physical apparatus. In other instances, however, such machine or system may be implemented in distributed manner—that is, with the various functions and/or operations attributed to the machine or system actually being performed or handled by various different physical components and/or devices, which may configured to interact with each other, such as to exchange data or control information and/or to coordinate handling the functions and/or operations.

The readable code (e.g., a barcode and/or a quick response (QR) code imprinted into the label 120) is configured such that it can be read in a particular manner (e.g., by scanning it), by electronic devices such as mobile devices (e.g., smartphones, tablets, etc.), personal computers, or dedicated devices (e.g., barcode and/or QR code scanners). The readable-code may be configured to allow reading it (e.g., by scanning) sing existing components, such as built-in cameras in mobile devices. The readable code may be configured to provide information beyond the general information that may typically be provided—e.g., information allowing for uniquely identifying the particular product item and/or the batch that included the particular item. For example, each product item and/or batch may be assigned a unique identifier—e.g., a unique serial or six digit number, which may be incorporated into each readable code “written” into the label 120 generated for each NDT product can. The code may identify the product being used (e.g. product name/part number).

Inclusion of such additional information—that is, batch and/or item identification information, in addition to general information relating to the NDT product as a whole, may be desirable as allows for enhancing NDT operations. For example, batch and product identifiers allow obtaining relating to the particular batch and the particular product item—e.g., when the product was made, details on the actual composition, etc. The batch identifier may be a six digit unique identifier.

In an example implementation, the readable code is configured to allow automatic connection to websites providing additional information relating to the product in general and to the batch in particular. Further, in some instances, on the provider/manufacturer side, once a user establishes a connection based on scanning of the readable code, and gains access the product/batch information, further actions may be taken. Such further actions may include marketing actions (e.g., offers for additional samples, other possibly related products, etc.), online refills, notifications relating to the product in general and/or batch in particular (e.g., recalls), etc.

In an example implementation, the label 120 and/or the readable code incorporated thereon may be configured to enable users to utilized particular systems or devices for obtaining information relating to the NDT products, such as by configured to take or perform particular actions based on the readable code of the label 120. For example, with respect to the use scenario shown in FIG. 1, a user uses an electronic device 130 (e.g., a smartphone) to scan the readable code on the label 120. In this regard, an application 140 may be installed on the electronic device 130 for use in scanning and handling the readable code. For example, the application 140 may display the area where a built-in camera would be focused on, corresponding to the readable code in the label 120, with an on-screen button to trigger the scanning. In this regard, as illustrated in FIG. 1, the electronic device 130 may be configured to scan different types of readable codes, such as barcodes as illustrated on the right-side of the label 120, or QR codes, as illustrated on the left-side of the label 120. It should be understood, however, that the readable code on the label 120 may typically correspond to only one type—e.g., would typically either be a barcode or QR code. Nonetheless, the disclosure is not so limited, and in some instances, labels implemented in accordance with the present disclose may incorporate different types of readable codes and/or other incorporated information. Once scanned, the electronic device 130 (e.g., via the application 140 running therein) may handle the readable code, and to do so based on and/or using the unique product and/or batch identifiers read from the code.

For example, handling the readable code may entail launching a product related graphical user interface (GUI) 150 that provides information relating to the NDT product 110 and/or for allowing the user to provide further instructions or input. Once the readable code is scanned, the application 140 may automatically, for example, open a browser connected to predefined websites(s) or webpage(s) corresponding to the NDT product 110. The unique product and/or batch identifiers read from the code may then be utilized, either automatically (e.g., based on them being read during the scanning) or based on user input (e.g., with the identifiers being displayed, and then (re-)entered by the user) to obtain information particular to the specific product sample and corresponding batch.

In an example implementation, extracted NDT product related information, such as the unique product identifier and/or batch identifiers, and/or actions triggered based thereon (e.g., connections to providers and/or website associated therewith) may be utilized to provide various services and/or applications that may specifically customized based on the particular product and/or batch. Examples of such services may include: providing batch certificates (for use in delivering batch information to end users), delivery of safety data sheets (SDS) to end users, process tracking (e.g., log a parts process through a multi-stage system), system setup (e.g., configure the system for appropriate material or accessories), equipment logging (e.g., tracking which materials, accessories or equipment was used for a test), reorder points (e.g., enable online transactions), returns tracking (e.g., return merchandise authorization (RMA) transactions), product feedback (e.g., enable surveys and product feedback), service support (e.g., remote service information and updates based on product information), warranty (e.g., enable product warranties and update contact information), customer support (e.g., initiate and track support requests), track usage history (e.g., volume of materials used), track user efficiency (e.g., number of tests by user/system), etc.

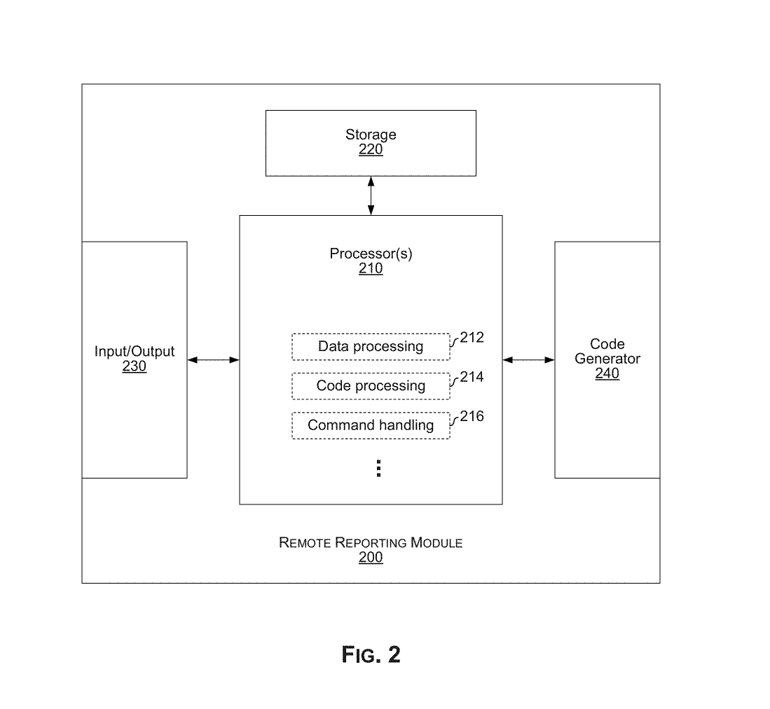

FIG. 2 depicts an example system for generating and/or applying readable codes for non-destructive testing (NDT) products, in accordance with aspects of this disclosure. Shown in FIG. 2 is an example readable code generating system 200.

The readable code generating system 200 may comprise suitable circuitry for handling generating enhanced readable codes for use in NDT material or products. In this regard, the readable code generating system 200 may be operable to generate readable codes and/or labels incorporating such codes for NDT products, including codes incorporating product and/or batch related information, as described above with respect to FIG. 1.

As shown in FIG. 2, the readable code generating system 200 may comprise a processing component 210, storage component 220, a remote interface (I/F) component 230, and a local interface (I/F) component 240.

The processing component 210 comprises suitable circuitry for performing processing operations in the readable code generating system 200. For example, the processing component 210 may be operable to process data (e.g., collected data obtained from local entities); run or execute various functions, tasks, and/or applications; and/or configure, control, and/or manage operations of the readable code generating system 200 and/or other components and/or subsystems (or operations thereof) in the readable code generating system 200. For example, the processing component 210 may incorporate a data processing function 212 configure for processing data, particularly data relating to the NDT material and/or products, such as based on input provided by system operators, pre-stored information and the like, for use in generating corresponding readable codes; a code processing function 214 for generating control information that may be used in generating readable code (e.g., control parameters that may be fed into code generating algorithms and/or software); and a command handling function 216 for handling received commands (commands for controlling the system, commands requesting generating readable code, commands specifying details about the codes, etc.).

The storage component 220 may comprise suitable circuitry for providing permanent and/or non-permanent storage, buffering, and/or fetching of data, which may be used, consumed, and/or processed in the readable code generating system 200. In this regard, the storage component 220 may comprise different memory technologies, including, for example, read-only memory (ROM), random access memory (RAM), Flash memory, solid-state drive (SSD), and/or field-programmable gate array (FPGA). The storage component 220 may store, for example, configuration data, which may comprise parameters and/or code, comprising software and/or firmware; functions or system settings; libraries; etc. In some implementations, the storage component 220 may be used to store NDT related data, such as details relating to particular products, batches, and/or items thereof.

The input/output (I/O) component 230 may comprise suitable circuitry for supporting input/output (I/O) operations in the readable code generating system 200, such as to enable receiving input from and/or providing output to users of the system. The I/O component 230 may support various types of input and/or output, including audible, graphical, textual, etc. In this regard, the readable code generating system 200 may incorporate internal/built-in I/O devices for receiving input and/or providing output; alternatively or in combination, the readable code generating system 200 may be coupled to external dedicated input and/or output devices, with the I/O component 230 handling interaction with and/or use of such external devices. Examiner I/O devices may include screen/display, camera, scanner, keyboard, keypad, mouse, speaker(s), microphone, etc. The readable code generating system 200 may support input/output (I/O) operations for allowing user interactions which may be needed for controlling the readable code generating system 200 or operations thereof—e.g., allowing users to provide input or commands, for controlling certain functions or components of the readable code generating system 200, and/or to output or provide feedback pertaining to functions or components. For example, the I/O component 230 may allow receiving commands and pertinent information (e.g., general product information, product identifier, batch identifier, etc.) relating to generation of readable codes for application to NDT products.

The code generator 240 may comprise suitable circuitry for handling generation of readable codes. In this regard, the code generator 240 may generate based on information obtained by other components of the readable code generating system 200 (e.g., the I/O component 230, particularly as processed in the processor 210) machine-readable code pertaining to NDT products. The readable code may be configured for scanning. The readable-code may be incorporated into labels applied to NDT products. In this regard, in some instances the code generator 240 may incorporate suitable dedicated devices for printing the labels and/or for applying them directly to the NDT product. Alternatively or in combination, the code generator 240 may interact with external devices or systems, for handling the printing and/or application of the labels.

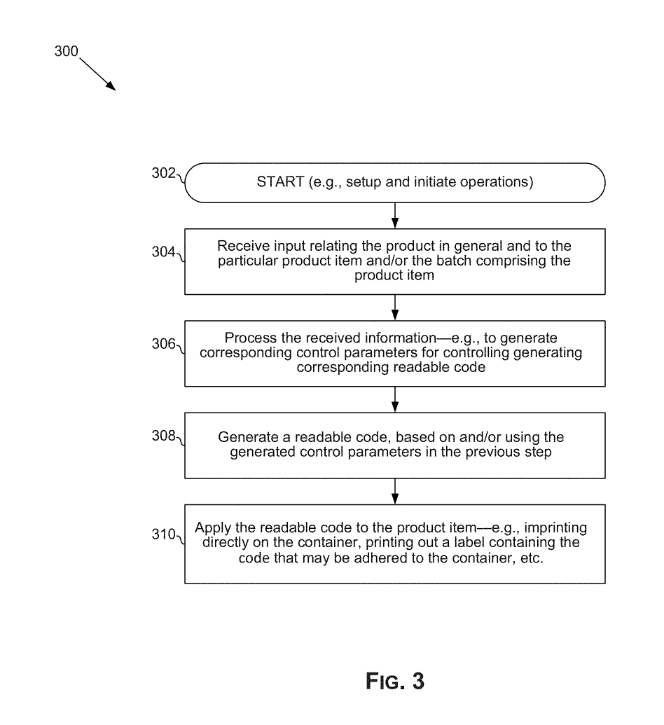

FIG. 3 depicts a flowchart of an example process for generating readable codes for non-destructive testing (NDT) products, in accordance with aspects of the present disclosure. Shown in FIG. 3 is flow chart 300, comprising a plurality of example steps (represented as blocks 302-310), for generating readable codes for non-destructive testing (NDT) products, using a suitable system (e.g., the readable code generating system 200 of FIG. 2), in accordance with the present disclosure.

After start step 302, in which the system used to generate the readable codes is setup and configured for welding, operations may be initiated in step 304.

In step 304, input (e.g., commands and/or pertinent information) relating the product in general and to the particular product item and/or the batch comprising the product item may be received.

In step 306, the received information may be processed—e.g., to generate corresponding control parameters for controlling generating corresponding readable code.

In step 308, a readable code may be generated based on and/or using the generated control parameters in the previous step.

In step 310, the generated readable code is applied to the product item—e.g., imprinting directly on the container, printing out a label containing the code that may be adhered to the container, etc.

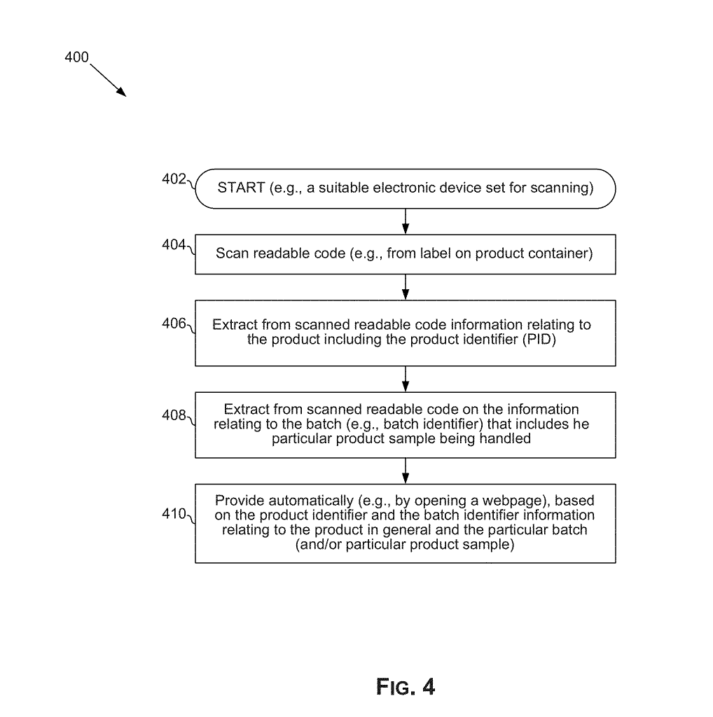

FIG. 4 depicts a flowchart of an example process for utilizing readable codes for non-destructive testing (NDT) products, in accordance with aspects of the present disclosure. Shown in FIG. 4 is flow chart 400, comprising a plurality of example steps (represented as blocks 402-410), for utilizing readable codes associated with non-destructive testing (NDT) products, using a suitable system (e.g., the electronic device 130 of FIG. 1), in accordance with the present disclosure.

After start step 402, in which the system (e.g., the electronic device 130) is set for handling the readable code (e.g., the application 140 is launched), operations may be initiated in step 404.

In step 404, the readable code may be scanned (e.g., from label on product container).

In step 406, code information relating to the product including the product identifier (PID) may be extracted from scanned readable code.

In step 408, information relating to the batch (e.g., batch identifier) that includes the particular product sample being handled may be extracted from scanned readable code.

In step 410, the extracted information may be utilized, such as to provide automatically (e.g., by opening a webpage), based on the product identifier and the batch identifier information relating to the product in general and the particular batch (and/or particular product sample).

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A system, comprising:
a reading component configured for reading machine-readable code incorporated into a label applied to a non-destructive testing (NDT) product; and
one or more circuits configured to:
process data obtained from the machine-readable code;
extract based on the processing, information relating to the NDT product; wherein the extracted information comprises at least one of a unique product identifier and a unique batch identifier; and
trigger based on at least one of the unique product identifier and the unique batch identifier, one or more actions associated with at least one of the NDT product and use of the NDT product.

2. The system of claim 1, comprising an output component configured for providing output based on or relating to the triggered one or more actions.

3. The system of claim 2, wherein the output component comprises a display.

4. The system of claim 1, wherein one or more circuits are configured to automatically establish a connection to a remote entity associated with the NDT product.

5. The system of claim 4, wherein one or more circuits are configured to obtain from the remote entity information relating to at least one of the NDT product and a specific batch comprising to the NDT product.

6. The system of claim 5, wherein one or more circuits are configured to obtain from the remote entity information relating to the specific batch based on the unique batch identifier.

7. The system of claim 1, wherein one or more circuits are configured to open a user interface for providing information relating to one or more of the NDT product, use of the NDT product, and a batch that comprises the NDT product.

8. The system of claim 1, wherein one or more circuits are configured to automatically open a specific webpage or website associated with the NDT product based on the extracted information.

9. A non-transitory machine-readable storage stored thereon a computer program comprising at least one code section comprising a plurality of instructions executable by a machine comprising at least one processor, to cause the machine to perform a plurality of steps comprising:
reading machine-readable code incorporated into a label applied to a non-destructive testing (NDT) product;
processing information obtained from the machine-readable code;
extracting based on the processing, information relating to the NDT product; wherein the extracted information comprises at least one of a unique product identifier and a unique batch identifier; and
performing one or more actions associated with the NDT product based on at least one of the unique product identifier and the unique batch identifier.

10. The non-transitory machine-readable storage of claim 9, wherein the one or more actions comprise automatically establishing a connection to a remote entity associated with the NDT product.

11. The non-transitory machine-readable storage of claim 10, wherein the one or more actions comprise obtaining from the remote entity information relating to at least one of the NDT product and a specific batch comprising to the NDT product.

12. The non-transitory machine-readable storage of claim 11, wherein the one or more actions comprise obtaining from the remote entity information relating to the specific batch based on the unique batch identifier.

13. The non-transitory machine-readable storage of claim 9, wherein the one or more actions comprise opening a user interface for providing information relating to one or more of the NDT product, use of the NDT product, and a batch that comprises the NDT product.

14. The non-transitory machine-readable storage of claim 9, wherein the one or more actions comprise automatically opening a specific webpage or website associated with the NDT product based on the extracted information.

15. A label configured for application to non-destructive testing (NDT) products, the label comprising:
a readable code that incorporates information relating to a particular non-destructive testing (NDT) product sample, the information being configured to uniquely identify at least one of the NDT product sample and a batch comprising the NDT product sample;
wherein:
the readable code is configured for being read via a machine, and
the reading of the readable code allows for extraction of the incorporated information.

16. The label of claim 15, wherein the readable code comprises a barcode.

17. The label of claim 15, wherein the readable code comprises a QR code.

18. The label of claim 15, wherein the readable code is configured for reading via scanning.

19. The label of claim 15, wherein the readable code is configured for causing the machine to automatically open a specific webpage or website associated with the particular NDT product based on the extracted information.

20. The label of claim 15, wherein the readable code is configured for causing the machine to open a user interface for providing information relating to one or more of the NDT product, use of the NDT product, and a batch that comprises the NDT product.
